(19) United States
(12) Patent Application Publication
(10) Pub. No.: US 2021/0237257 A1
(43) Pub. Date: Aug. 5, 2021

(54) Non-Slip Tool For Manipulating A Cord

(71) Applicant: Jules Anton Van Dongen, Santa Clara, CA (US)

(72) Inventor: Jules Anton Van Dongen, Santa Clara, CA (US)

(21) Appl. No.: 16/779,585

(22) Filed: Feb. 1, 2020

(51) Int. Cl. B25J 1/04

(52) U.S. Cl. CPC B25J 1/04

(57) ABSTRACT

A Tool comprises a rod attached to a Head adapted to manipulate a Cord. The Head has at least one surface adapted to impeding the Cord from sliding across the Head, and may have another surface adapted to allowing the Cord to slide across the Head. The Tool user can manipulate the Tool by holding the Cord up on it against different parts of the Head surface.

### FIELD

This pertains to the field of hand-held tools for home, security, military, agricultural and industrial applications.

### Glossary

Contact Surface—The surface of the Holder adapted to touch a Cord

Cord—A long thin flexible structure used to make a physical connection

Actor—A person or machine manipulating a Cord

to grip—To impede an object touching another object from slipping freely against the other object

Gripper—A part of a Contact Surface which is adapted to touch a Cord and by friction reduce its propensity to slide along the Contact Surface

Handler—A tool by which an Actor manipulates a Cord, comprising a straight Handle and a Holder

Handle—Here, the handle of the Handler

Axis of the Handle—A geometric line segment which runs through the length of the handle of the Handler

Holder—The part of a Handler adapted to touch upon, engage and manipulate a Cord

Plane of the Holder—A plane which contains one of the two largest faces of the smallest rectangular cuboid which completely contains the Holder.

Axis of Engagement—A geometric line segment which runs through the length of the Holder

to slide—To allow a touching object to slip freely against the object in question

Slider—A part of a Contact Surface which is adapted to touch a Cord but not prevent it from sliding

### BACKGROUND

Define Cord to be a thin, linear, flexible structure, potentially with along its length one more features which do not impede its thinness and flexibility as a whole. It is possible to tie a Cord into a knot if the ends of the Cord are free. It is also possible to tie a section of cord into a loop knot. Examples of Cords include but are not limited to: lanyards, unknotted ropes, knotted ropes, straight electrical power Cords, Christmas light strings, chains of links, chains of balls, chains of beads, barbed wire, individual sections between connections in a net, hoses, tubes, and cables.

In many venues there is a need for a tool to manipulate a Cord at a distance, for instance to hang it from a hook, or alternately to remove the Cord from a hook from which it is already hanging. Such a tool is useful when manipulating such a Cord requires the person or machine manipulating the Cord, called the Actor, to put himself, herself or itself in some difficult and potentially dangerous position, e.g. on a ladder, or scaffold, or uneven terrain, while human attention focuses on engaging or disengaging the Cord.

E.g.: Consider the case of an Actor hanging a line of outdoor Christmas lights from a series of hooks attached to the eaves of a house. Such eaves are generally at least one story off the ground, and an Actor hanging such lights by hand generally must climb a ladder to do so. This is both more laborious and more dangerous than need be. The Actor must move the ladder, which is work in itself; and climbing on it may by ill chance fall off of it, and such a fall may potentially result in injury to a person or damage to a machine doing the work.

E.g.: Consider the case of an Actor hanging up a net or a line of barbed wire on an elevated fence structure. This is laborious work and the barbed wire itself may injure a human Actor. An easier way for a human Actor to manipulate a Cord rather than holding it by hand, is to use a tool called a Handler to hold the Cord at a distance from the Actor. If this tool is itself light enough to manipulate easily, and holds the Cord at a sufficient distance, then there is no need for the Actor to move physically off the ground, or to change position to elevate the Cord.

Alternately a mechanical Actor such as a robot will be more effective if it manipulates a Handler to extend its reach. A robotic Actor requires a Handler in any case, since it has no other means of controlling the Cord. In some cases this may allow the mechanical Actor to reach places that are inaccessible to it with other mechanisms. In other cases this may allow the mechanical Actor to reach places that are less readily accessible to it with other mechanisms.

### PRIOR ART

Various tools are available to hold and to manipulate a Cord at a distance.

One set of such tools are variations on the following basic design: The Handler comprises a rod attached to an object, called a Holder, which is adapted to secure the Cord when the Handler is moved in some ways, but to release the Cord when the Holder is moved in others.

In some typical cases the Holder is flattened with a thickness between one-eighth inch and two inches. In such a case we define the Plane of the Holder as the plane which contains one of the two largest faces of the smallest rectangular cuboid which completely contains the Holder. Then the Holder is adapted to hold a Cord in such a way that at the locus of the Holder touching the Cord, the Cord passes through the plane of the Holder.

Define the Contact Surface as the surface of the Holder adapted to touch the Cord when the Actor is manipulating the Cord with the tool. In many such cases the Handler is adapted to hold the Cord against the Contact Surface by the force of gravity. In these cases the Actor rests the Cord on the Contact Surface by gravity, and then moves the Handler, which moves the Cord along with it. In such cases the Actor engages the Cord with the handler by placing the Contact Surface under the Cord and then lifting the Cord until gravity rests the Cord against the Handler. Then the Actor moves the Handler until the Cord is in the desired location and resting upon some material object. Then the Actor disengages the Handler from the Cord by distancing the Handler in such a way that the Cord is left resting upon said material object.

E.g. Suppose the Actor puts up a a Cord which is a string of Christmas lights, i.e. a length of insulated pair of electrical wires with Christmas lights attached to them, on eaves with hooks attached to them to hang such a Cord. To do this he places the Cord on the Contact Surface of the handler, so the Cord rests on the Handler. He then manipulates the Handler and moves it, carrying the Cord with it, so that the Cord comes to rest upon a hook or other material object installed in the eaves. Then he lowers the Handler so that the Cord is left resting on the hook and not on the Handler. Then the Actor engages the next section of the Cord to place it on the next hook or some other material object. He continues this process until the desired length of the Cord is on the desired hooks. When the Actor takes down the Cord, he reverses the process by engaging the string with the Handler near a hook, disengaging the Cord from the hook with the Handler, and then disengaging the Handler from the Cord. He does this in sequence until the Cord is disengaged from all desired material objects.

The geometry of the Holder is varied. In some cases it is a simple flat or concave surface on which the Cord rests. In other cases the Holder presents a concavity or a slot, straight or tapered, in which the Cord fits; and into which, and from which, the Actor can manipulate the Cord.

The problem with the Handler in the prior art is that it is typically fabricated from durable plastic or metal. The Contact Surface either does not constrain a Cord resting on it except by force of gravity. So the Contact Surface does not prevent the Cord from sliding perpendicularly to the Plane of the Holder when the Actor uses the Handler to move the Cord.

### SUMMARY OF THE INVENTION

The present disclosure teaches a Handler which comprises a Handle and a Holder. The improvement over prior art is that some or all of the Holder presents a non-abrasive friction element to touch the Cord, to impede it from sliding against the Holder.

The Holder is adapted to lift a Cord in such a way that where the Cord touches the Handler the Cord is perpendicular or nearly perpendicular to the Plane of the Handler, which is a plane which contains the Holder and the Handle.

When the Actor holds it upright the Handler presents on top of the Holder a Contact Surface. The Contact Surface comprises at least one non-abrasive friction element, called a Gripper. The Contact Surface may also comprise at least one smooth element, called a Slider. The Sliders and Grippers are separated so that when the Handler engages a Cord that Cord does not touch both a Slider and a Gripper at the same time. When the Handler is held upright both Sliders and Grippers present concavities facing upwards.

A Gripper is adapted to impede by friction the Cord slipping across the Handler. When the Handler engages a Cord with a Gripper such a concavity causes a Cord suspended across the Gripper to remain suspended that way without sliding across the Gripper.

A Slider is adapted to allow such a Cord to slide perpendicularly against the Plane of the Holder. When the Handler engages a Cord with a Slider such a concavity causes a Cord suspended across the Slider to remain suspended that way while freely sliding across the Slider.

The Actor engages a Cord with the Handler by holding the Handler upright under the Cord and then lifting the Handler until the Handler engages the Cord with either a Gripper or a Slider. If the Handler engages the Cord with a Slider then the Actor can slide the Handler against the Cord. If the Handler engages the Cord with a Gripper then the Actor holds the current point of contact on the Cord as the Actor moves the Handler and thus the Cord around.

Because both Grippers and Sliders are non-abrasive, contact between the Cord, and either a Gripper or a Slider, does not damage the Cord.

### BRIEF DESCRIPTION OF THE DRAWINGS

FIG. 1 shows an example embodiment from a side view. The Holder (101) has an Insertion point (105) which is adapted to have the Handle (102) screwed in by threading (106) and thereby held securely. The Holder has a Gripper (103) whose surface is made of elastomer, and a Slider (104) whose surface is made of the same plastic as the rest of the Handler. An Actor lifts the Handler by means of the Handle and holds the Cord by force of gravity against either the Gripper or the Slider.

FIG. 2 shows the same example embodiment at FIG. 1 but from rotate 3d view. The Holder (101) has an Insertion point (105) which is adapted to have the Handle (102) screwed in by threading (106) and thereby held securely. The Holder has a Gripper (103) whose surface is made of elastomer, and a Slider (104) whose surface is made of the same plastic as the rest of the Handler. An Actor lifts the Handler by means of the Handle and holds the Cord (111) by force of gravity against either the Gripper or the Slider.

FIG. 3 shows an example embodiment from a side view. The Holder (205) flanges out (204) to an Insertion Point (202) which is adapted to have the Handle (201) inserted into it and lock in place by a Screw (203). In this embodiment the Holder has a Gripper (206, 207, 208) but no Slider. It is adapted to raise a Cord (221) held against the Gripper surfaces by force of gravity.

FIG. 4 shows an example embodiment from a side view. The Holder (305) flanges out (304) to an Insertion Point (302) which is adapted to have the Handle (301) inserted into it and lock in place by a Screw (303). In this embodiment the Holder has a Gripper (306) while the rest of it (305) is a Slider. It is adapted to raise a Cord (321) held against the Gripper surface or the Slider surface by force of gravity.

FIG. 5 shows another example embodiment from a side view. The Holder (406) flanges out (404) to an Insertion Point (402) which is adapted to have the Handle (401) inserted into it and lock in place by a Screw (403). The Holder is narrow but supported vertically by a Gusset (405). The end of the Holder away from the Handle is covered by a Gripper (409) made of surgical tubing. The rest of the top of the Hold (406) is the Slider. The Gripper has an Elevated Distal Tip (410). The Slider is bracketed by two Nubs (407, 408). A Cord (421) lies across the Gripper (409).

### EMBODIMENTS

### All Embodiments

In an embodiment:

The Plane of the Holder is a plane parallel to the largest faces of the smallest rectangular cuboid which completely contains the Handler and which contains the Axis of the Handle.

The Handler comprises a Handle and a Holder.

The Contact Surface is the surface of the Holder that is uppermost when the Actor holds the Handler upright, meaning with the Handle held vertically and the Holder above it.

The Contact Surface contains at least one Gripper and at least one Slider.

A Gripper is a surface of the Holder that is adapted to prevent a Cord from sliding against it by means of friction between the Gripper and the Cord.

A Slider is a surface of the Holder that is adapted to allow a Cord to slide against it perpendicular to the Plane of the Holder.

In some embodiments Slider presents a downward concavity. This restricts a Cord engaged with a Slider from slipping against the Slider in a direction other than one perpendicular to the Plane of the Holder.

In some embodiments Slider is bracketed on one side, the other, or both by elevations. This restricts a Cord engaged with a Slider from slipping against the Slider in a direction other than one perpendicular to the Plane of the Holder.

In some embodiments a Gripper presents a downward concavity. This augments the grip of the Gripper on a Cord touching it. In some other embodiments a Gripper does not present a downward concavity.

In some embodiments Gripper is bracketed on one side, the other, or both by elevations. This restricts a Cord engaged with a Gripper from slipping against the Gripper in a direction other than one perpendicular to the Plane of the Holder.

The Handler Tool is adapted to engage with a Cord, which presses down on it by the force of gravity. When the Handler Tool engages a Cord, the the Cord rests on one Slider or Gripper. When the Cord rests on a Gripper, it cannot slip against the Handler. When the Cord rests on a Slider the Cord may slip against the Handler.

In some embodiments the Cord is secured against the Handler Tool by the force of gravity.

### Manufacturing Embodiments

In some embodiments the Holder comprises plastic. In some embodiments the Holder comprises ceramic. In some embodiments the Holder comprises metal.

In some embodiments some or all of the Holder is manufactured by injection molding.

In some embodiments some or all of the Holder is manufactured by extrusion.

In some embodiments some or all of the Holder is manufactured by casting.

In some embodiments the Holder is manufactured in one piece.

In some embodiments the Holder is manufactured in multiple pieces.

In some embodiments the Gripper is manufactured of some elastomer. In some such embodiments the Gripper is manufactured of some elastomer from this list: rubber, rubber cement, or latex. In some embodiments the Gripper is manufactured from some other elastomer. In some embodiments the Gripper is manufactured from some class of material other than elastomers.

### Alternative Embodiments

In some embodiments the Holder contains metal. In some embodiments the Holder contains plastic. In some embodiments the Holder contains wood. In some embodiments the Holder contains other materials.

In some embodiments the rod attaches to the Handler by screwing into it. In some embodiments the rod attaches to the Handler by a pin mechanism such as a cotter pin. In some embodiments the rod snaps into place into the body of the Holder. In some embodiments the rod attaches to the Handler by friction. In some embodiments the rod attaches to the Handler by some other mechanism. In general such mechanisms are well known and well understood in the Art.

In some embodiments the rod telescopes. In some embodiments the rod does not telescope.

In some embodiments the rod comprises metal. In some embodiments the rod comprises wood. In some embodiments the rod comprises plastic. In some embodiments the rod comprises some other metal.

In some embodiments the Gripper comprises elastomer, including but not limited to rubber and gum. In some embodiments the Gripper comprises plastic. In some embodiments the Gripper comprises some other type of substance.

In some embodiments the geometry of a Gripper concavity is angular. In some embodiments this geometry is rounded.

In some embodiments the geometry of a Slider concavity is angular. In some embodiments this geometry is rounded.

In some embodiments the geometries of the Holder are rounded to prevent a Cord from catching on a feature of the Holder.

In some embodiments the cross section of the Holder is rectangular. In some embodiments it is round. In some embodiments it is some other shape.

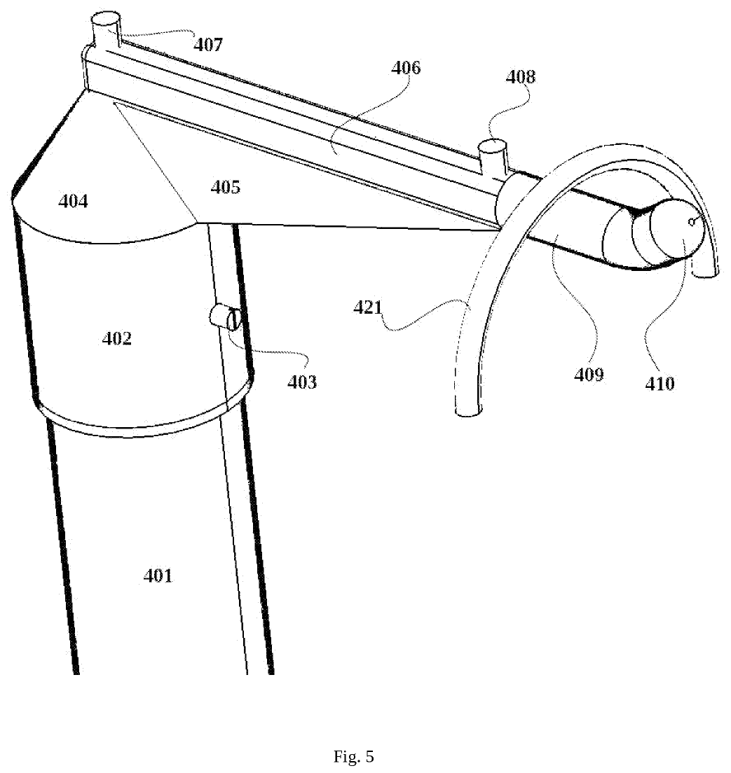

In some embodiments the Holder has a gusset as shown in FIG. 5 to strengthen it structurally.

In some embodiments the Gripper is on the distal end of the Holder from the Handle. In some other embodiments it is not.

In some embodiments the Slider is on the distal end of the Holder from the Handle. In some other embodiments it is not.

### Example Embodiment 1

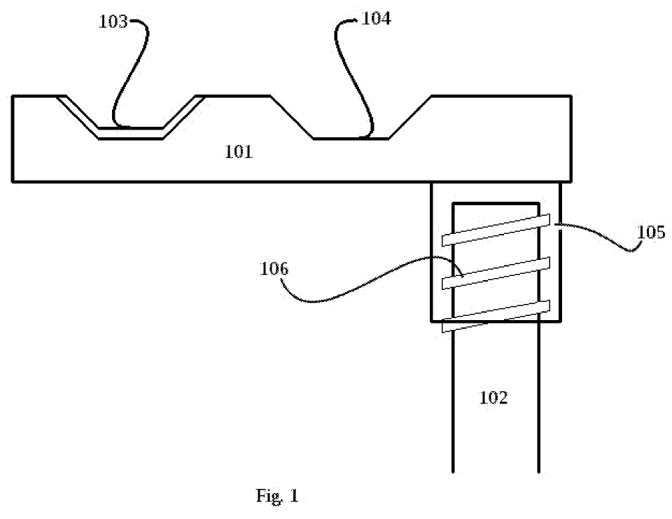

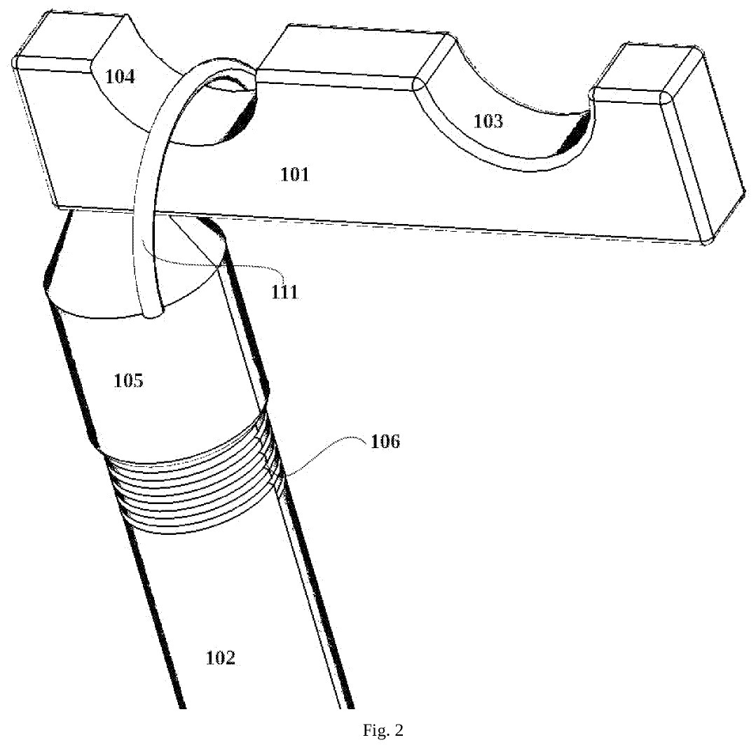

In an embodiment as shown in FIG. 1 and FIG. 2 a Handler is specially adapted to put up and bring down a string of Christmas lights. Such a string of lights comprises sections of Cord and lights between them. The sections of Cord contain electrically conducting wire completely enclosed in a non-conducting rubber or elastomer casing.

The Handler Tool comprises a telescoping handle (102), and a Holder (101) made of plastic. In this embodiment the Handle screws into an Insertion Point (105) of the Holder.

The body of the Holder is shaped to be longest in a direction perpendicular to the rod, and flat at its top which is defined to be the side away from the length of rod.

The natural means of holding the Holder is for the Actor to hold the Handler vertically or almost vertically. In this case the Actor can raise the Holder against a Cord so that the Cord rests on the Gripper (103) or the Slider (104), by the choice of the Actor. If the Actor raises the Cord against the Gripper then the Gripper maintains some friction on the Cord to prevent it from slipping perpendicularly against the Handler. If the Actor raises the Cord against the Slider then the Slider has little or no friction against the Cord to prevent it from slipping perpendicularly against the Handler.

### Example Embodiment 2

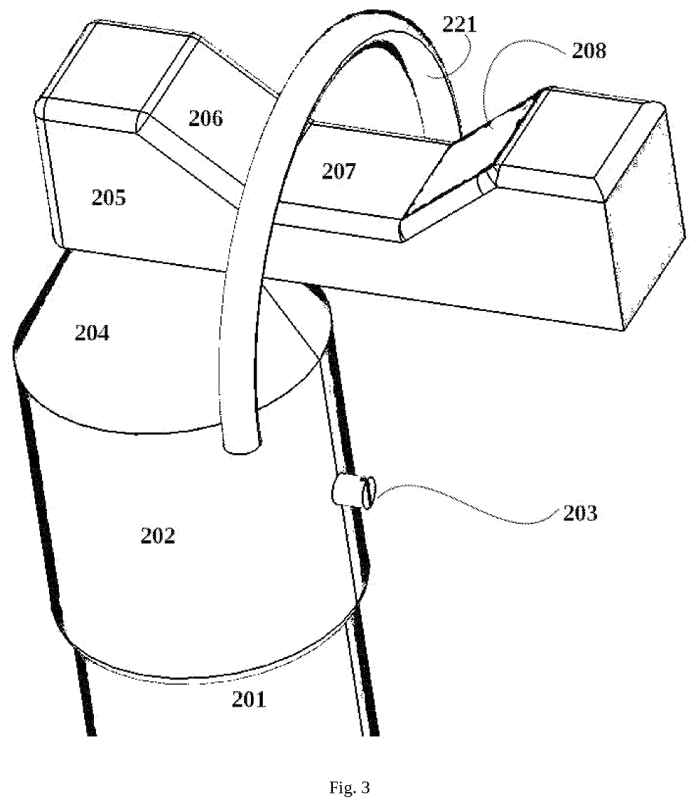

In an embodiment as shown in FIG. 3 a Handler is specially adapted to put up and bring down a string of Christmas lights. Such a string of lights comprises sections of Cord and lights between them. The sections of Cord contain electrically conducting wire completely enclosed in a non-conducting rubber or elastomer casing.

The Handler Tool comprises a Handle (201), and a Holder (205) made of plastic. In this embodiment the Handle (201) inserts into the Insertion Point (202) straight and is kept in place by a Screw (203).

The body of the Holder is shaped to be longest in a direction perpendicular to the rod, and flat at its top which is defined to be the side away from the length of rod.

In this embodiment the Holder has a Gripper (206, 207, 208) which is a surface covered by an elastomer adapted to grip at a Cord (221) pressing against it. In this embodiment there is no Slider.

The natural means of holding the Holder is for the Actor to hold the Handler vertically or almost vertically. In this case the Actor can raise the Holder against a Cord so that the Cord rests on the Gripper (103). If the Actor raises the Cord against the Gripper then the Gripper maintains some friction on the Cord to prevent it from slipping perpendicularly against the Handler.

### Example Embodiment 3

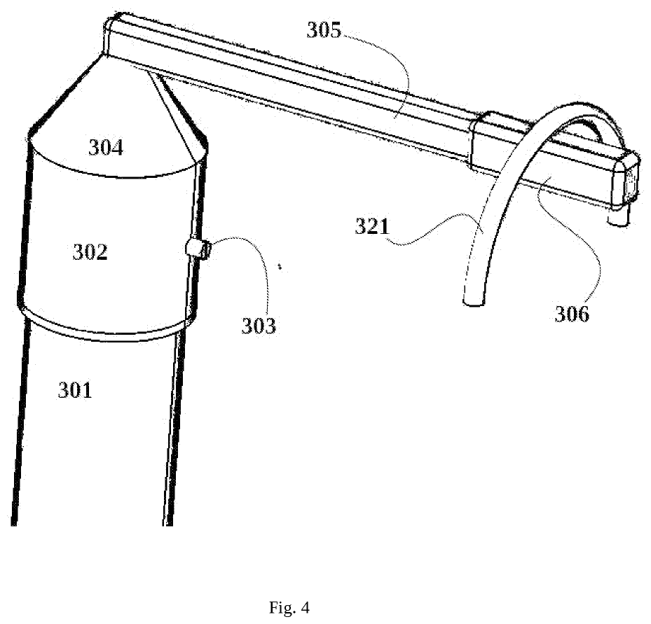

In an embodiment as shown in FIG. 4 the Handler Tool comprises a Handle (301) and a Holder (305) which attach to the Handle through a Flange (304) by an Insertion Point (303) which is secured with a Screw (303). The Holder has on its end a Gripper (306). The Gripper grips a Cord (321) when that Cord lies across it.

In this embodiment when a Cord (321) lies across the Gripper (306), the Gripper impedes the Cord's ability to slide. But when it lies across other parts of the Holder (305) which are effectively a Slider, the Cord may slide freely.

The mechanics of how the this embodiment and the previous one function are mostly identical. The difference is in the geometry of the Holder. Here the Holder is flat, which no elevations or dips. This allows the Actor to elevate the Cord to a desired feature without that or some other feature impeding the Holder, since the Cord is the highest point of the combination of the Handler Tool and the Cord. The drawback is that since the Gripper has no dip there is nothing but the grip of the Gripper to impede the Cord from sliding off of it.

### Example Embodiment 4

In an embodiment as shown in FIG. 5 the Handler Tool comprises a Handle (401) and a Holder (406) which attach to the Handle through a Flange (404) by an Insertion Point (302) which is secured with a Screw (403). This embodiment has a Gusset (405) which adds vertical rigidity. The Holder has on its end a Gripper (409) with an elevated distal Tip (410). A Cord (421) lies across the Holder.

In this embodiment when a Cord (421) lies across the Gripper (409), the Gripper impedes the Cord's ability to slide. But when it lies across other parts of the Holder (305) which are effectively a Slider, the Cord may slide freely.

The mechanics of how the this embodiment and the previous one function are mostly identical. The difference is in the geometry of the Holder. Here the Holder has elevations around the Gripper (408, 410) to secure further a Cord (421) across it from sliding off. And there are elevations around the Slider (407, 408) to prevent a Cord lying across the Slider from sliding off of either end of the Slider. Relative to the previous embodiment the elevations may slightly impede the Actor in elevating the Cord to a desired feature without that or some other feature impeding the Holder, since the elevations (407, 408, 410) may be the highest point of the combination of the Handler Tool and the Cord. However, this may not be a drawback since the Handler is meant to elevate a Cord onto a feature such as a hook. The elevations are limited to between 0.1 and 1.5 inches in height.

Also the Holder (406) is between 0.1 and 0.5 inches in width. This allows for greater access and maneuver in positioning the Holder in tight or otherwise geometrically constrained places. Also it allows a human Actor greater ability to look around the Holder at the Cord and the features on which to hang it.

### OTHER EMBODIMENTS

We show these varied and numerous embodiments of the invention to be exemplary and in no way limiting. Many other embodiments are possible, without departing from the spirit of the invention or sacrificing its advantages.

### Advantages

The advantage of the invention over the prior art is that it prevents a Cord manipulated by a Holder from slipping against the Holder if the Cord is touching the Gripper, and allows this slipping when the Cord does not touch the Gripper but only Slider, and allows the Actor to shift the Cord back and forth between the Slider and the Gripper by manipulating the Handler. This allows the Actor to exercise more precise control over the Cord.

### CONCLUSIONS, RAMIFICATIONS AND SCOPE

In conclusion this invention of adding a Gripper to a Handler tool will enable Actors—human or mechanical—greater ability and ease in suspending a Cord for the purpose of manipulating it onto and off of structures adapted to suspend such Cord. Such an advantage may save time and effort on the part of all who must manipulate such Cords.

We claim:

1. A holder tool adapted to lifting a cord secured from falling out of it by gravity, where the surface of said holder tool adapted to touch said cord presents to said cord a contact surface with non-abrasive friction, thereby preventing said cord from slipping along the length of said cord against said holder tool.

2. The holder tool of claim 1 where the contact surface with non-abrasive friction comprises a depression adapted to secure said cord further by the force of gravity.

3. The holder tool of claim 1 with an additional contact surface with minimal friction between said cord and said holder tool.

4. The holder tool of claim 3 where the contact surface with minimal friction comprises a depression adapted to secure said cord further by the force of gravity.

5. The holder tool of claim 1 where the body of the tool is between 0.1 and 0.5 inches wide.
